(19) United States
(12) Patent Application Publication
(10) Pub. No.: US 2012/0260213 A1
(43) Pub. Date: Oct. 11, 2012

(54) ELECTRONIC DEVICE AND METHOD FOR ARRANGING USER INTERFACE OF THE ELECTRONIC DEVICE

(75) Inventor: CHENG-KUO YANG, Tu-Cheng (TW)

(73) Assignee: CHI MEI COMMUNICATION SYSTEMS, INC., Tu-Cheng (TW)

(21) Appl. No.: 13/297,159

(22) Filed: Nov. 15, 2011

(30) Foreign Application Priority Data
Apr. 7, 2011 (TW) 100112094

(51) Int. Cl. G06F 3/048

(52) U.S. Cl. 715/810

(57) ABSTRACT

In a method for arranging a user interface displayed on a touchscreen of an electronic device, a first touch operation is received from the touchscreen when the electronic device receives a trigger instruction for arranging the user interface. The method confirms an icon on a current page displayed on the touchscreen to be moved according to the first touch operation, and controls the confirmed icon to move towards coordinate values of the first touch operation. If a second touch operation has been received while receiving the first touch operation, the method further confirms an orientation of the second touch operation, and controls the current page of the user interface to move towards the orientation of the second touch operation. If the first touch operation has not been received, the method positions the confirmed icon on the user interface.

### BACKGROUND

1. Technical Field

Embodiments of the present disclosure relate to user interface systems and methods, and more particularly to an electronic device and method for arranging a user interface of the electronic device.

2. Description of Related Art

Many electronic devices (e.g. smart phones with a touchscreen) support a home screen with multiple pages or with application launchers, to allow a user to freely choose or arrange the applications he/she desires in the electronic device. The user can arrange icons of the applications on different pages of a user interface of the electronic device. If the user wants to move an icon of an application on a current page to a different page, the user may drag the icon to the edge of the current page, and push one half of the icon outside the current page, to switch pages in the user interface and find a desired page. Icons may be limited in size by the size of the touchscreen of the electronic device. Therefore, the arrangement of the icons in multiple pages may not be convenient enough.

### BRIEF DESCRIPTION OF THE DRAWINGS

FIG. 1 is a block diagram of one embodiment of an electronic device including an arrangement system.

FIG. 2 is a block diagram of function modules of the arrangement system included in the electronic device of FIG. 1.

FIG. 3A and FIG. 3B are examples of the movement of shortcut icons in different pages of a user interface.

FIG. 4 is a flowchart of one embodiment of a system for arranging a user interface of the electronic device of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word module, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

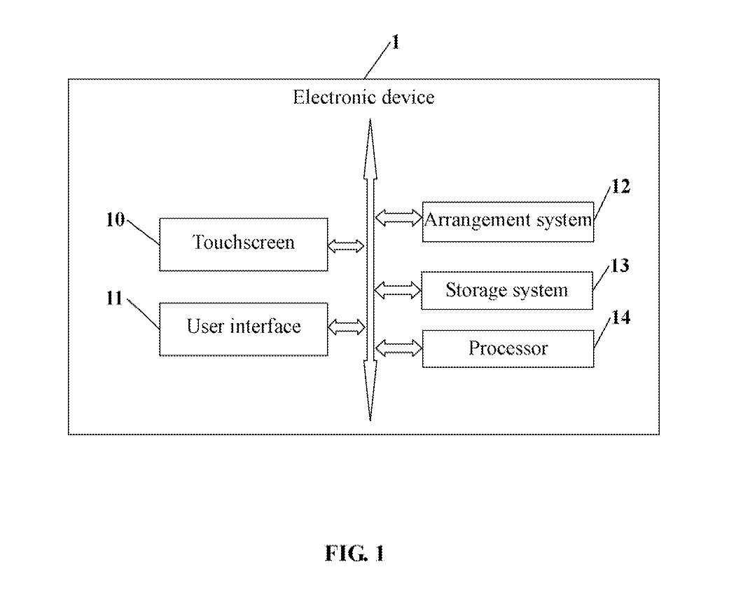

FIG. 1 is a block diagram of one embodiment of an electronic device 1 including an arrangement system 12. The electronic device 1 further includes a touchscreen 10 and a user interface 11. The touchscreen 10 may be a capacitive touchscreen supporting multi-touch operations. In the embodiment, the multi-touch operations may define at least two touch operations on the touchscreen, such as simultaneously tapping and touching on the touchscreen 10 using fingers. The touchscreen 10 may identify and detect the at least two touch operations simultaneously. The user interface 11 may be shown on the touchscreen 10, and includes a plurality of pages. Each of the pages includes different icons (i.e. shortcuts) of applications or menus of the electronic device 1. The touchscreen 10 displays one current page of the user interface 11 to be operated. The arrangement system 12 may arrange and move an icon from a current page to another page of the user interface 11 conveniently according to the multi-touch operations.

The electronic device 1 further includes a storage system 13 and at least one processor 14. The storage system 13 stores data of the electronic device 1. The storage system 13 may be a memory of the electronic device 1, or an external storage card, such as a smart media card, or a secure digital card. The at least one processor 14 executes one or more computerized codes and other applications of the electronic device 1, to provide the functions of the arrangement system 12.

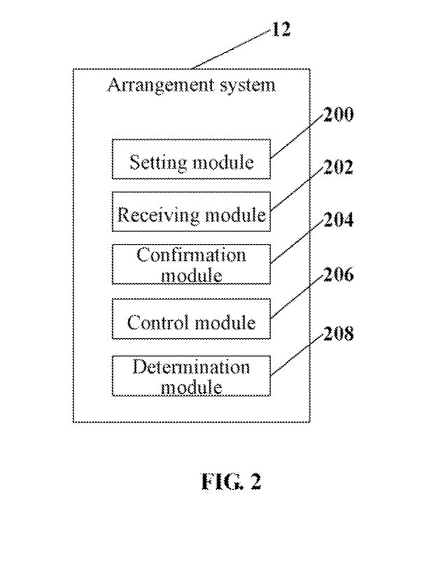

FIG. 2 is a block diagram of function modules of the arrangement system 12 included in the electronic device 1 of FIG. 1. In the embodiment, the arrangement system 12 may include a setting module 200, a receiving module 202, a confirmation module 204, a control module 206, and a determination module 208. The modules 200, 202, 204, 206, and 208 comprise computerized codes in the form of one or more programs that are stored in the storage system 13 of the electronic device 1. The computerized code includes instructions that are executed by the at least one processor 14 of the electronic device 1 to provide functions for the modules. Details of these operations follow.

The setting module 200 sets a trigger instruction for arranging the user interface 11. When the electronic device 1 receives the trigger instruction, the user interface 11 requires to be arranged. The trigger instruction may be a command generated by a long single press of a finger contacting any icon on a current page displayed on the touchscreen 10, or at any blank area of the current page. The long single press may be defined as a finger contacting the touchscreen 10 for a few seconds, such as, pressing for 2 seconds, for example. In one embodiment, the icons may be arranged in different positions of the pages of the user interface 11 according to user preference.

The receiving module 202 receives a first touch operation from a first finger contacting the touchscreen 10 in response to the electronic device 1 receiving the trigger instruction. The receiving module 202 may further receive a second touch operation from a second finger contacting the touchscreen 10 when the first touch operation is being received. That is, the receiving module 202 may simultaneously receive two touch operations from two fingers on the touchscreen 10. The touch operations on the touchscreen 10 may generate corresponding coordinate values to the touchscreen 10.

The confirmation module 204 confirms one icon on the current page displayed on the touchscreen 10 to be moved according to the first touch operation. In one embodiment, the icon may be a logo, one or more characters, or a combination of the logo and the one or more characters. The confirmation module 204 further confirms coordinate values of the first touch operation on the touchscreen 10.

The control module 206 moves the confirmed icon towards the confirmed coordinate values of the first touch operation.

The determination module 208 determines whether a second touch operation has been received from the touchscreen 10 when the first touch operation is being received.

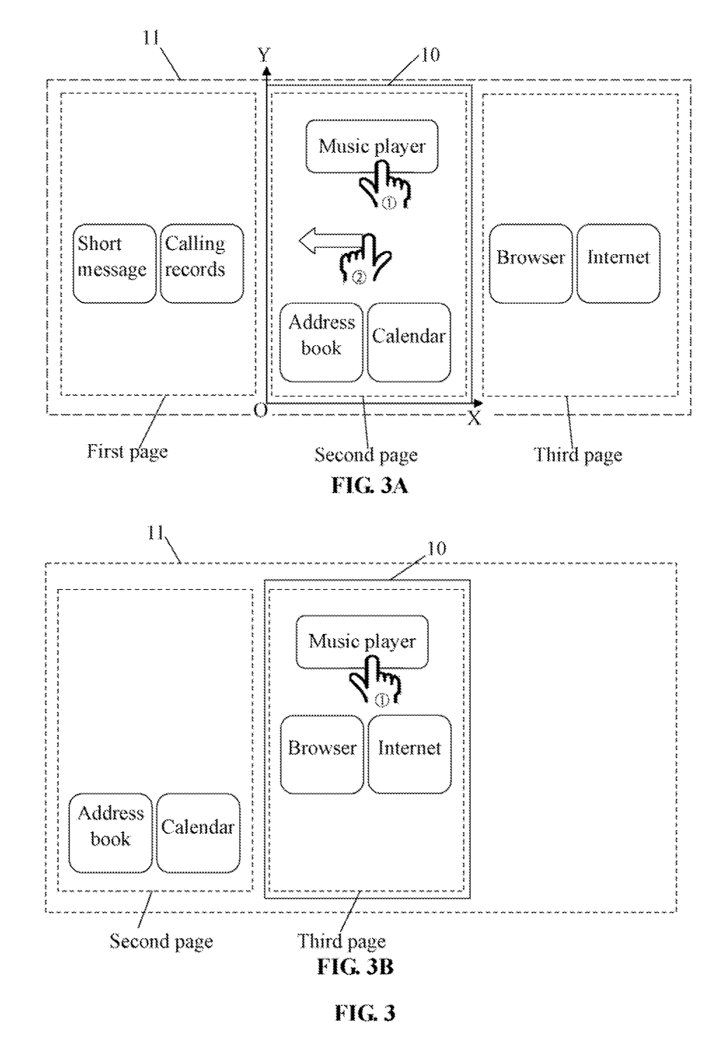

The confirmation module 204 further confirms an orientation of the second touch operation, when both the first touch operation and the second touch operation have been received. As shown in FIG. 3A, an exemplar coordinate system of the touchscreen 10 is shown. The coordinate system defines a point in the lower left corner of the touchscreen 10 as an origin, a horizontal direction of the touchscreen 10 as an X-axis, and a vertical direction of the touchscreen 10 as a Y-axis. In one embodiment, the orientation of the second touch operation may be leftward or rightward. If X-coordinate values of the second touch operation based on the coordinate system of the touchscreen 10 increase (e.g. an increase along the X-axis), the orientation of the second touch operation is confirmed as rightwards. If the X-coordinate values of the second touch operation based on the coordinate system decrease (e.g. a decrease along the X-axis), the orientation of the second touch operation is confirmed as leftwards. In other embodiments, the second orientation may be upward or downward, and the confirmation module 204 may confirm the second orientation according changes in Y-coordinate values (e.g. increase or decrease along the Y-axis) of the second touch operation based on the coordinate system.

The control module 206 further controls the current page of the user interface 11 according to the confirmed orientation of the second touch operation, to switch other page(s) of the user interface 11.

The determination module 208 further determines whether the electronic device 1 has received the first touch operation. When the electronic device 1 has not received the first touch operation, the control module 206 further confirms a new position of the confirmed icon according to the last coordinate values of the first touch operation on the touchscreen 10. That is, the control module 26 positions the confirmed icon on the user interface to finish the arrangement of the user interface 11.

FIG. 3A and FIG. 3B illustrate examples of the movement of icons in different pages of a user interface. In FIG. 3A, the user interface 11 includes a first page, a second page, and a third page. Each of the pages includes different icons of the electronic device 1. The current page displayed on the touchscreen 10 is the second page. When the confirmation module 204 confirms that a touch operation of the first finger (marked “\textcircled{1}” in the drawing) is the first touch operation, the confirmation module 204 confirms that the icon “Music player” is to be moved. The control module 206 controls the confirmed icon “Music player” to move according to the coordinate values of the first touch operation. When the receiving module 202 receives the second touch operation, such as, a touch operation of the second finger (marked “\textcircled{2}” in the drawing), at the same time as receiving the first touch operation, the confirmation module 204 confirms the orientation of the second touch operation. If orientation of the second touch operation is confirmed as leftwards, the user interface 11 may be controlled to leftwards. As shown in FIG. 3B, the third page may be displayed on the touchscreen 10 after the user interface 11 has moved leftwards, and the confirmed icon “Music player” may thus be moved to the third page.

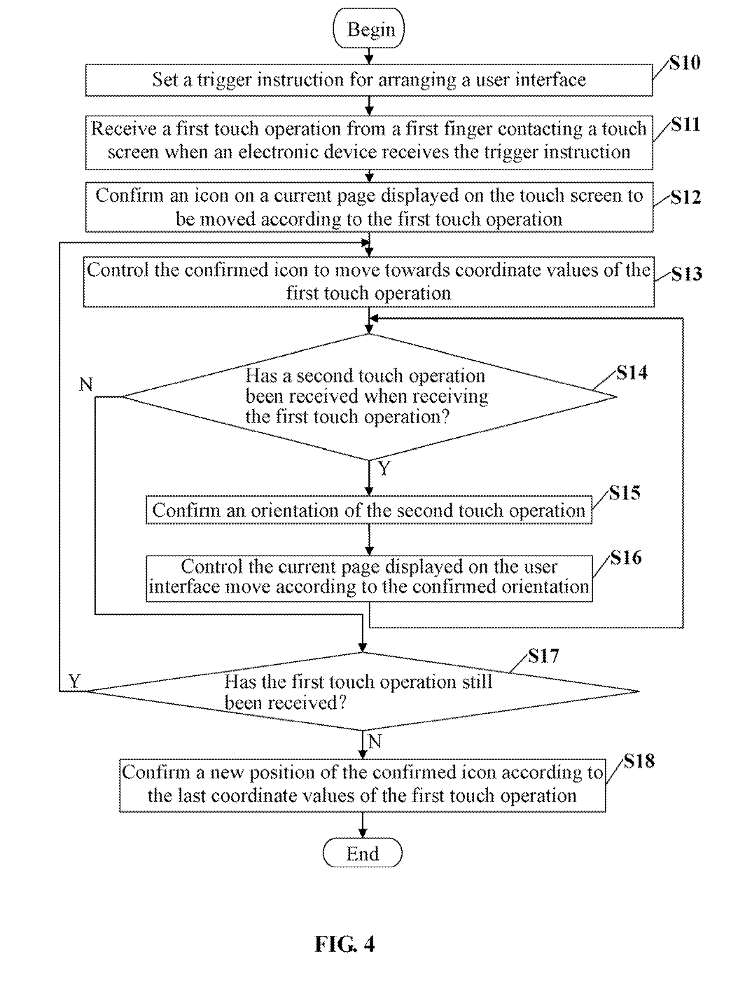

FIG. 4 is a flowchart of one embodiment of a method for arranging the user interface 11 of the electronic device 1 of FIG. 1. Depending on the embodiment, additional blocks may be added, others deleted, and the ordering of the blocks may be changed.

In block S10, the setting module 200 sets a trigger instruction for arranging the user interface 11. When the electronic device 1 receives the trigger instruction, the user interface 11 is prepared for arrangement. The trigger instruction may be a command generated by a long single press of a finger contacting any icon on a current page displayed on the touchscreen 10, or at any blank area of the current page. The long single press may be defined as a finger contacting the touchscreen 10 for a few seconds, such as, pressing for 2 seconds, for example.

In block S11, the receiving module 202 receives a first touch operation from a first finger contacting the touchscreen 10 in response to the electronic device 1 receiving the trigger instruction.

In block S12, the confirmation module 204 confirms one icon on the current page displayed on the touchscreen 10 to be moved according to first coordinate values of the first touch operation, when the receiving module 202 has received the first touch operation.

When the icon is confirmed, in block S13, the confirmation module 204 confirms coordinate values of the first touch operation, and the control module 206 moves the confirmed icon towards the coordinate values of the first touch operation.

In block S14, the determination module 208 determines whether the second touch operation has been received from a second finger contacting the touchscreen 10, when the first touch operation is being received. If the second touch operation has been received, block S15 is implemented. Otherwise, if the second touch operation has not been received, block S17 is implemented.

In block S15, the confirmation module 204 confirms an orientation of the second touch operation, when both the first touch operation and the second touch operation have been received. In one embodiment, the orientation of the second touch operation may be leftward or rightward. If X-coordinate values of the second touch operation based on the coordinate system of the touchscreen 10 increase (e.g. an increase along the X-axis), the orientation of the second touch operation is confirmed as rightwards. If the X-coordinate values of the second touch operation based on the coordinate system decrease (e.g. a decrease along the-X axis), the orientation of the second touch operation is confirmed as leftwards. In other embodiments, the second orientation may be upward or downward, and the confirmation module 204 may confirm the second orientation according changes in Y-coordinate values (e.g. increase or decrease along the Y-axis) of the second touch operation based on the coordinate system.

In block S16, the control module 206 controls the current page of the user interface 11 according to the confirmed orientation of the second touch operation to switch other page(s) of the user interface 11, and block S14 is repeated.

In block S17, the determination module 208 further determines whether the electronic device 1 has received the first touch operation. If the electronic device 1 has received the first touch operation, block S13 is repeated. Otherwise, if the electronic device 1 has not received the first touch operation, block S18 is implemented.

In block 518, the control module 206 confirms a new position of the confirmed icon according to the last coordinate values of the first touch operation on the touchscreen 10. That is, the control module 26 positions the confirmed icon on the user interface to finish the arrangement of the user interface 11.

All of the processes described above may be embodied in, and fully automated via, functional code modules executed by one or more general purpose processors. The code modules may be stored in any type of non-transitory readable medium or other storage device. Some or all of the methods may alternatively be embodied in specialized hardware. Depending on the embodiment, the non-transitory readable medium may be a hard disk drive, a compact disc, a digital video disc, a tape drive or other suitable storage medium.

The described embodiments are merely possible examples of implementations, and have been set forth for a clear understanding of the principles of the present disclosure. Many variations and modifications may be made without departing substantially from the spirit and principles of the present disclosure. All such modifications and variations are intended to be included herein within the scope of this disclosure and the described inventive embodiments, and the present disclosure is protected by the following claims.

What is claimed is:

1. A computer-implemented method for arranging a user interface displayed on a touchscreen of an electronic device, the method comprising:
in response to receiving a signal indicative of arrangement of the user interface displayed on the touchscreen from the electronic device, receiving a first touch operation from a first finger contacting the touchscreen;
confirming an icon on a current page of the user interface displayed on the touchscreen to be moved according to the first touch operation;
controlling the confirmed icon to move towards coordinate values of the first touch operation on the touchscreen;
determining whether a second touch operation has been received from a second finger contacting the touchscreen while the first touch operation is being received;
confirming an orientation of the second touch operation, upon the condition that the second touch operation has been received while receiving the first touch operation;
controlling the current page of the user interface to move according to the confirmed orientation; and
positioning the confirmed icon on the user interface when the first touch operation has not been received from the touchscreen.

2. The method as claimed in claim 1, wherein the orientation of the second touch operation is confirmed as rightwards upon the condition that X-coordinate values of the second touch operation based on a coordinate system of the touchscreen increase, and is confirmed as leftwards upon the condition that the X-coordinate values of the second touch operation based on the coordinate system decrease, the coordinate system of based on the touchscreen defining a point in the lower left corner of the touchscreen as an origin, a horizontal direction of the touchscreen as an X-axis, and a vertical direction of the touchscreen as a Y-axis.

3. The method as claimed in claim 2, wherein the orientation of the second touch operation is confirmed as upwards upon the condition that Y-coordinate values of the second touch operation based on a coordinate system of the touchscreen increase, and is confirmed as downwards upon the condition that the Y-coordinate values of the second touch operation based on the coordinate system decrease.

4. The method as claimed in claim 1, wherein the icon is confirmed according to the first coordinate values of the first touch operation.

5. The method as claimed in claim 1, wherein the touchscreen supports multi-touch operations.

6. The method as claimed in claim 1, wherein the user interface comprises a plurality of pages, each of the pages comprises a plurality of icons of the electronic device, and each of the icons is a logo, one or more characters, or a combination of the logo and the one or more characters.

7. A non-transitory storage medium storing a set of instructions, the set of instructions capable of being executed by an electronic device, causes the electronic device to perform a method for arranging a user interface displayed on a touchscreen of the electronic device, the method comprising:
in response to receiving a signal indicative of arrangement of the user interface displayed on the touchscreen from the electronic device, receiving a first touch operation from a first finger contacting the touchscreen;
confirming an icon on a current page of the user interface displayed on the touchscreen to be moved according to the first touch operation;
controlling the confirmed icon to move towards coordinate values of the first touch operation on the touchscreen;
determining whether a second touch operation has been received from a second finger contacting the touchscreen while the first touch operation is being received;
confirming an orientation of the second touch operation, upon the condition that the second touch operation has been received while receiving the first touch operation;
controlling the current page of the user interface to move according to the confirmed orientation of the second touch operation; and
positioning the confirmed icon on the user interface when the first touch operation has not been received from the touchscreen.

8. The storage medium as claimed in claim 7, wherein the orientation of the second touch operation is confirmed as rightwards upon the condition that X-coordinate values of the second touch operation based on a coordinate system of the touchscreen increase, and is confirmed as leftwards upon the condition that the X-coordinate values of the second touch operation based on the coordinate system decrease, the coordinate system of based on the touchscreen defining a point in the lower left corner of the touchscreen as an origin, a horizontal direction of the touchscreen as an X-axis, and a vertical direction of the touchscreen as a Y-axis.

9. The storage medium as claimed in claim 8, wherein the orientation of the second touch operation is confirmed as upwards upon the condition that Y-coordinate values of the second touch operation based on a coordinate system of the touchscreen increase, and is confirmed as downwards upon the condition that the Y-coordinate values of the second touch operation based on the coordinate system decrease.

10. The storage medium as claimed in claim 7, wherein the icon is confirmed according to the first coordinate values of the first touch operation.

11. The storage medium as claimed in claim 7, wherein the touchscreen supports multi-touch operations.

12. The storage medium as claimed in claim 7, wherein the user interface comprises a plurality of pages, each of the pages comprises a plurality of icons of the electronic device, and each of the icons is a logo, one or more characters, or a combination of the logo and the one or more characters.

13. An electronic device, comprising:
a touchscreen for displaying a user interface;
a storage system and at least one processor; and
one or more programs that are stored in the storage system and executed by the at least one processor, the one or more programs comprising:
a receiving module operable to receive a first touch operation from a first finger contacting the touchscreen in response to receiving a signal indicative of arrangement of the user interface displayed on the touchscreen from the electronic device;
a confirmation module operable to confirm an icon on a current page displayed on the touchscreen to be moved according to the first touch operation;
a control module operable to control the confirmed icon to move towards coordinate values of the first touch operation;
a determination module operable to determine whether a second touch operation has been received from a second finger contacting the touchscreen while the first touch operation is being received;
the confirmation module further operable to confirm an orientation of the second touch operation, upon the condition that the second touch operation has been received while receiving the first touch operation;
the control module further operable to control the current page of the user interface to move according to the confirmed orientation of the second touch operation, and position the confirmed icon on the user interface when the first touch operation has not been received from the touchscreen.

14. The electronic device as claimed in claim 13, wherein the orientation of the second touch operation is confirmed as rightwards upon the condition that X-coordinate values of the second touch operation based on a coordinate system of the touchscreen increase, and is confirmed as leftwards upon the condition that the X-coordinate values of the second touch operation based on the coordinate system decrease, the coordinate system of based on the touchscreen defining a point in the lower left corner of the touchscreen as an origin, a horizontal direction of the touchscreen as an X-axis, and a vertical direction of the touchscreen as a Y-axis.

15. The electronic device as claimed in claim 14, wherein the orientation of the second touch operation is confirmed as up upon the condition that Y-coordinate values of the second touch operation based on a coordinate system of the touchscreen increase, and is confirmed as down upon the condition that the Y-coordinate values of the second touch operation based on the coordinate system decrease.

16. The electronic device as claimed in claim 13, wherein the icon is confirmed according to the first coordinate values of the first touch operation.

17. The electronic device as claimed in claim 13, wherein the touchscreen supports multi-touch operations.

18. The electronic device as claimed in claim 13, wherein the user interface comprises a plurality of pages, each of the pages comprises a plurality of icons of the electronic device, and each of the icons is a logo, one or more characters, or a combination of the logo and the one or more characters.
